(19) United States
(12) Patent Application Publication
(10) Pub. No.: US 2003/0235237 A1
(43) Pub. Date: Dec. 25, 2003

(54) Spread-spectrum channel searcher and method for accelerating searching in a CDMA receiver

(76) Inventor: Lev Smolyar, Haifa (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 10/177,246

(22) Filed: Jun. 20, 2002

(51) Int. Cl. H04B 1/69

(52) U.S. Cl. 375/148

(57) ABSTRACT

A wideband CDMA searcher and method accelerate searching for signal paths of a spread-spectrum signal. I and Q components of a received signal may be sampled at approximately once per chip and summed over one or more symbols to determine a measured channel value at a specific delay. The delay between sequentially checked paths may be one chip or less. A channel value may be estimated for each delay of the spreading code based in the measured channel values. A signal path may be selected based on the channel value for use in subsequent signal tracking.

### FIELD OF THE INVENTION

The present invention pertains to spread spectrum communications.

### BACKGROUND OF THE INVENTION

Code division multiple access (CDMA), and particularly direct sequence CDMA, is a technique for spread-spectrum digital communications used for many applications, including, for example, mobile communications. In direct sequence CDMA, data signals are combined with a spreading waveform in the form of a pseudo-random-noise code (e.g., a spreading code) to form a coded signal for transmission. The spreading code has a frequency, referred to as a chip rate, which may be a multiple of the frequency (i.e., the bit-rate or symbol-rate) of the data signal. The effect of combining the data signal and the spreading code is that the symbol-period is divided into smaller chip periods. At the receiver, the signal is combined with the same spreading code to extract the data signal. The technique provides high data capacity by spreading signal energy over a wide bandwidth to increase bandwidth utilization and reduce the effects of narrow-band interference.

In direct sequence CDMA, the spreading code of the transmitter and receiver should be synchronized within as little as one chip period to achieve reliable communication. In most of the cases it may be much less than 1 chip. Multipath effects make synchronization more difficult since the wireless channel from a base station to a reception device may have several signal paths of different time-delays, which may vary due to the movement of the reception device.

CDMA receivers conventionally include a searcher function to identify and synchronize with the strong signal paths of different delays. The searcher function has been implemented by conventional spread spectrum receivers to determine a channel value at a specific delay. A searcher attempts to correlate channel values through a range of various amounts of delay to determine a delay amount at which the best correlation occurs.

One problem with conventional searchers and methods of searching is that searching requires time, consumes power and requires additional hardware. All of these are at a premium, especially in portable communication devices. Another problem with conventional searchers and methods of searching is that signals are sampled at two to four times per chip to prevent performance degradation. This requires time, consumes power and requires additional hardware.

Thus, there is a general need for a method and apparatus that provides accelerated searching for signal paths in a spread spectrum receiver.

### BRIEF DESCRIPTION OF THE DRAWINGS

The appended claims point out different embodiments of the invention with particularity. However, the detailed description presents a more complete understanding of the present invention when considered in connection with the figures, wherein like-reference numbers refer to similar items throughout the figures and:

FIG. 1 is a functional block diagram of an example CDMA receiver in accordance with an embodiment of the present invention;

FIG. 2 is a functional block diagram of an example searcher in accordance with an embodiment of the present invention;

FIG. 3 illustrates sampling of a combined response of transmit and receive filters in accordance with an embodiment of the present invention;

FIG. 4 is a table illustrating an example of signal sampling start times and pseudo-random initial phase in accordance with an embodiment of the present invention; and

FIG. 5 is a flow chart of a procedure for accelerating searching in accordance with an embodiment of the present invention.

### DETAILED DESCRIPTION

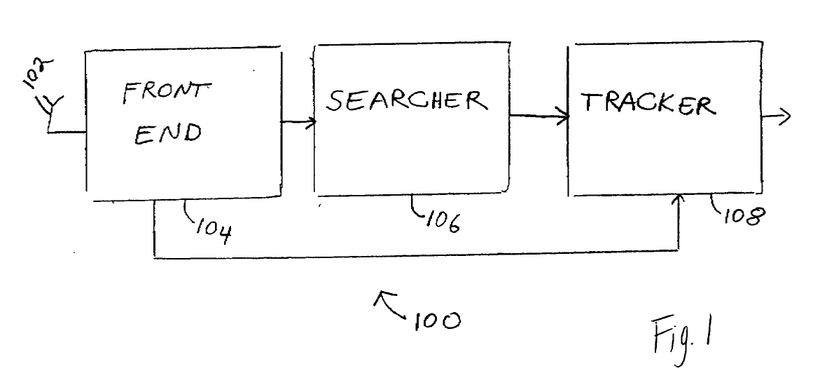

The description set out herein illustrates the various embodiments of the invention and such description is not intended to be construed as limiting in any manner. The present invention pertains to spread spectrum communications, and in several embodiments, to searchers and methods for searching for signal paths in code division multiple access (CDMA) receivers. FIG. 1 is an example functional block diagram of a CDMA receiver in accordance with an embodiment of the present invention. FIG. 1 illustrates only a portion of the functional elements that may be relevant to the embodiments of present invention, and those skilled in the art will understand that a CDMA receiver may have additional functional elements not illustrated. Receiver 100 may be part of a one-way or two-way communication device, such as, for example, a wireless telephone, a two-way radio, a two-way data communication device, or a receiver that is part of end user communication equipment. Receiver 100, among other things, despreads spread-spectrum signals with locally generated spreading codes. In receiver 100, searcher 106 performs a synchronization process to help ensure that each path of spread spectrum signal is correlated with the proper spreading code. The synchronization process includes a searching process, which is performed by searcher 106 to search for strong signal paths and to determine delays associated with the strong signal paths. During the searching process, various timing delays for a spreading code may be used to despread each signal path. Tracker 108 performs a tracking process to track signal paths identified by their delay by searcher 106.

Receiver 100 receives spread-spectrum signals through antenna 102 or other input element, which may be down converted, to a baseband signal by front-end 104 where the “in-phase” (I) and “quadrature-phase” (Q) components may be extracted. The received signal may be any spread-spectrum signal. In a wideband CDMA (WCDMA) embodiment, the signal may be, for example, a dedicated channel, a pilot channel or some other predetermined channel. The I and Q components may be converted to digital signals by an A/D converter, for example, by sampling the analog signals at a sampling rate. The digitized I and Q signals may be shaped by a filter. In other embodiments, filtering may be performed before the A/D converter. Other portions of receiver 100 may include other filters. Shaping may also be performed by a shaping filter such as a finite impulse response (FIR) filter, infinite impulse response (IIR) filter, for example or other type of filter which may provide a shaped moving average of the signal. A transmitting base station may have used a similar pulse-shaping filter in the transmission of the signal. In a WCDMA embodiment, for example, a pulse-shaping filter at both the transmitter and receiver may implement a raised-root cosine function, which may, for example, have a roll-off factor around 0.22.

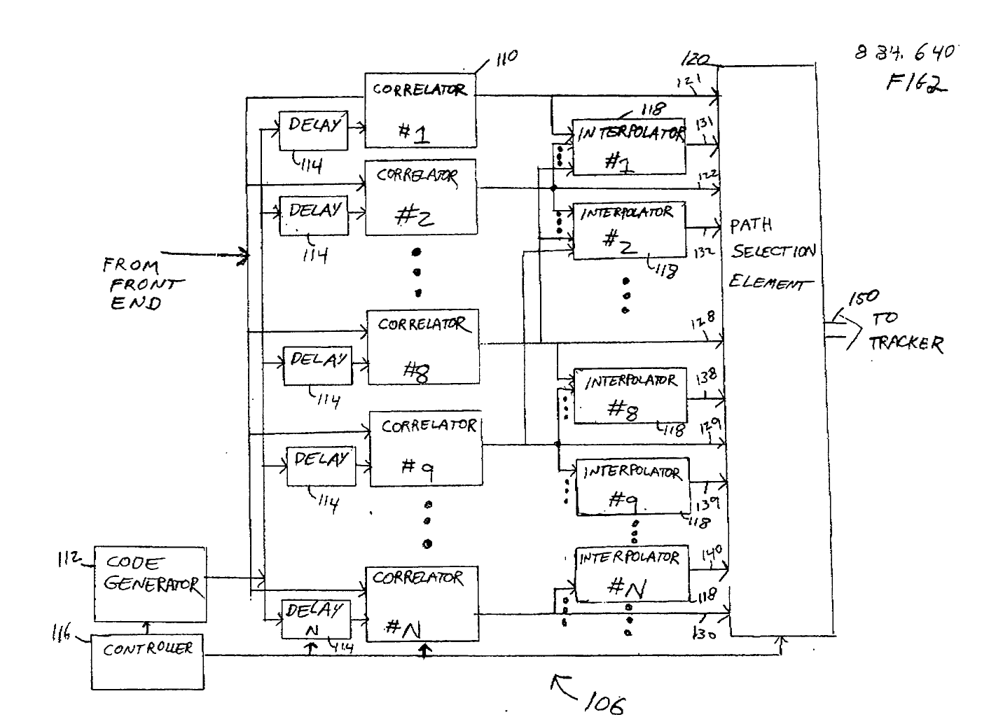

FIG. 2 is a functional block diagram of an example searcher in accordance with an embodiment of the present invention. Searcher 106 includes correlators 110, delay elements 114, interpolator elements 118 and path selection element 120, which may functionally comprise a searcher to performing a searching process. Correlators 110 operate on the I and Q digital signals to correlate the signals with a spreading code generated by code generator 112. The spreading code received by each correlator 110 may be delayed by one of delay elements 114. During the searching process, controller 116, among other things, sets the delay for each of delay elements 114. Interpolator elements 118 may coherently sum the measured channel value output from correlators 110 with appropriate weights to construct an approximation of the received signal for each delay. One or more channel values with an associated delay may be selected by path selection element 120. Path selection element 120 may perform other or additional functions including, for example, estimating channel power and summing channel power over time. Selected paths 150 may be provided for subsequent use by tracker 108 during the tracking mode.

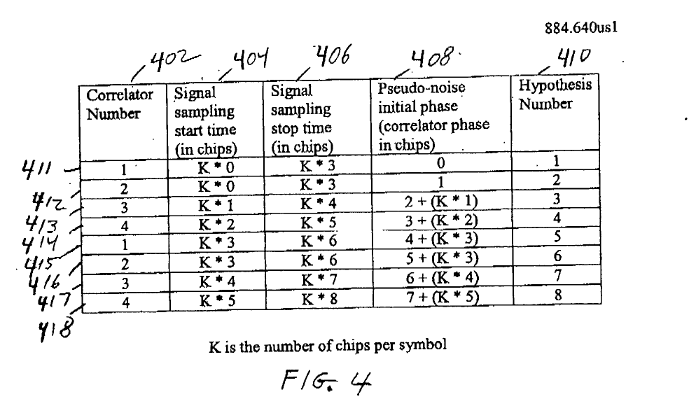

During the searching process, each correlator 110 multiples the I and Q signals with the spreading code and sums the result over one or more symbols. Because of the different delays resulting from delay elements 114 and signal sampling start time (see FIG. 4), each correlator's output represents a measured channel value with different delay characteristics. The measured channel values 121 through 130 may be complex values.

Interpolator elements 118 provide estimated channel values 131 through 140 for delay paths from the measured channel values from several of correlators 110. A channel value may be the amplitude and phase of signal received for particular delay. Interpolator elements 118 may generate channel value estimates by implementing one of many interpolation functions. An interpolation function may include any filter function, including low-pass filter functions such as a sin c (x) function. The channel value, as a function of delay, may have a bandwidth determined by bandwidth of input filters, which may be close to the inverse of the chip rate (e.g., 1/Tchip). Therefore, the channel value may be accurately estimated with measurements at approximately the chip rate (e.g., a T-chip sampled version).

In one embodiment of the present invention, there may be N correlators 110 and N-K+1 interpolator elements 118, where K is interpolation length. In this example, K is equal to eight (see below). However one interpolator may perform the function of one or more, or even all of interpolator elements 118. Interpolator elements 118 are illustrated as separate functional elements to aid in the understanding of the present invention. In this embodiment, each interpolator element 118 may receive measured channel values from a predetermined group of correlators. The number N of correlators 110 included in receiver 100 may depend on the speed with which correlation is desired, as well as other physical constraints including power consumption and space. The number of correlators 110, for example, may range from two to twenty or more.

In the example illustrated, each interpolator element 118 may receive consecutive measured channel values from eight correlators. For example, interpolator element #1 receives measured channel values at times t₁ through t₈ from correlators #1 through #8 respectively. Interpolator #2 receives measured channel values at times t₂ through t₉ from correlators #2 through #9 respectively, etc. In this example, interpolator element #N may receive measured channel values at times N through times t_{(N+7)} from correlators #N through #N+7 respectively.

In one embodiment, each correlator 110 may provide measured channel values 121 through 130. The difference between delays of two closest channel measurements may be about one chip or so. The delay of the measured channel is defined as the difference between a pseudo-noise initial phase and a signal sampling start time. For example, channel value 121 provided by correlator #1 may have a delay of approximately zero chips, and channel value 122 provided by correlator #2 may have a delay of approximately one chip. Likewise, channel value 128 provided by correlator #8 may have a delay of approximately seven chips, and channel value 129 provided by correlator #9 may have a delay of approximately eight chips. Also in this embodiment, interpolator elements 118 provide interpolated channel values 131 through 140 with a chip delay that may depend on the function implemented by the interpolators. For example, when interpolator elements 118 implement a sin c (x) function, certain input channel values are weighted more heavily. In this case, interpolator element #1 provides channel value 131 which may have approximately a 3.5 chip delay because it operates on measured channel values from correlators #1 through #8. Likewise, interpolator element #2 provides channel value 132 which may have approximately a 4.5 chip delay because it operates on measured channel values from correlators #2 through #9.

In one embodiment, the difference between delays of two consecutive correlators may be less than one chip. For example, consecutive correlators may be delayed therebetween by approximately 0.50, 0.75 or 0.875 chips. Other delays between consecutive correlators may also be suitable. In one embodiment of the present invention, the function of some of the various elements illustrated in FIG. 2 may be performed by one or more functional elements by one or more processors, such as one or more digital signal processors configured with software. For example, the function of one or more of correlators 110, delay elements 114, interpolator elements 118, code generator 112 and controller 116 may be performed by one or more such functional elements.

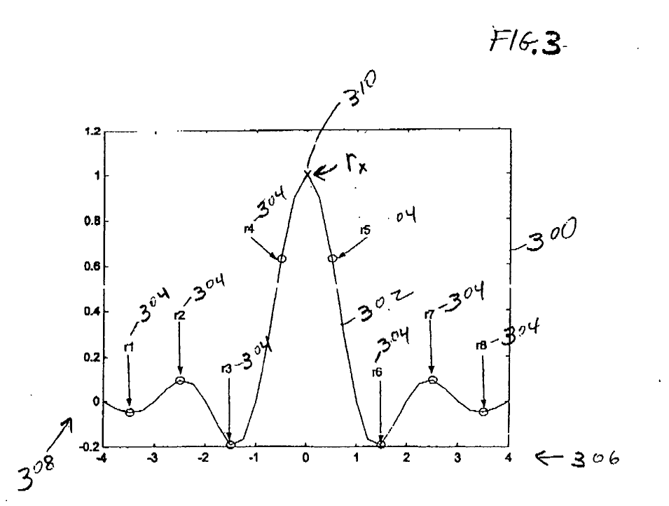

FIG. 3 illustrates sampling of an equivalent transmitter/receiver filter in accordance with an embodiment of the present invention. Graph 300 illustrates reconstruction of a signal 302 for channel value 310 at delay zero. The shape of reconstructed signal 302 may comprise the convolution of transmitter and receiver filters, and in this example, signal 302 illustrates the convolution of two square root raised cosine filters. This channel value would be the channel value measured by the searcher if there were no multipath components. For example, this would be the case if the channel comprised only one signal path or one reflection and the reflection did not rotate the signal. X-axis 306 is a time-axis illustrating delay in number of chips. Y-axis 308 is an amplitude axis and may be a normalized value with the signal peak set to 1.0. The signal may be sampled at approximately the chip rate resulting in samples r1 through r8 at various chip delays. The channel value at delay 0 (i.e., correlated output) may be estimated by any function, which, for example, may be a sin c( ) function.

In the example illustrated, the convolution of transmitter and receiver squared root raised cosine filter functions are illustrated. In this example, the channel value may be estimated by interpolator elements 118 (FIG. 2) implementing the following equation:

rₓ=sin c(t₁)r₁+sin c(t₂)r₂+sin c(t₃)r₃+sin c(t₄)r₄+sin c(t₅)r₅+sin c(t₇)r₇+sin c(t₈)r₈

In this equation, “t₁” through “t₈” are the delays between a measured channel value and the estimated channel value (in chips). “Sin c (t₁)” through “sin c (t₈)” are weighting factors and “sin c (x)” is the (sin πx)/πx function. In the embodiment where raised-root cosine filters are used, t₁ may be approximately 3.5, t₂ may be approximately 2.5, t₃ may be approximately 1.5, t₄ may be approximately 0.5, t₅ may be approximately −0.5, t₆ may be approximately −1.5, t₇ may be approximately −2.5 and t₈ may be approximately −3.5.

In one embodiment, receiver 100 (FIG. 1) may implement an off-line searcher. In this embodiment, either each correlator uses delayed versions of the spreading code (or the scrambling sequence as applicable) or the input signal samples are delayed. In another embodiment, receiver 100 (FIG. 1) may implement an on-line searcher. Generally, the number of paths that may be checked (i.e., the number of hypotheses') in parallel is equal to the number of correlators. Additional paths may be checked after a delay, which may be equal to the correlation length. Interpolation accuracy may degrade, however due to this delay. To help reduce this degradation in interpolation accuracy in this embodiment of the present invention, correlators are started with an appropriate delay so that a maximal delay between the check of two consecutive hypotheses is approximately less than or equal to one symbol. This is described in an example illustrated by FIG. 4.

Many conventional searchers sample at a rate that may be at least two to four times per chip resulting in a delay between consecutive correlators of between 0.25 or 0.5 chips. By sampling at approximately once per chip in accordance with one or more the embodiments of the present invention, power consumption may be reduced by as much as fifty percent or more. Furthermore, the amount of hardware for searching and search time may also be reduced.

FIG. 4 is a table illustrating an example of signal sampling start times and pseudo-random initial phase in accordance with an embodiment of the present invention. Table 400 may be used by controller 116 (FIG. 2), for example, to determine signal sampling start times 404 and pseudo-random initial phases 408 for correlators 110 (FIG. 2). In the example illustrated by table 400, there are four correlators identified in column 402, each having signal sampling start times 404 measured in a number of chips, and signal sampling stop times 406 measured in a number of chips. K is the number of chips per symbol and may be for example, 256 chips per symbol, although other values for K including 128 chips per symbol may also be suitable. The difference between sampling start times 404 and signal sampling stop times 406 is the correlation length, and for the example illustrated, is three symbols.

Measured channel values may be calculated by correlators 110 (FIG. 2) which may implement the following equation:

$${\sum }_{i = 0}^{CorrelationLenth - 1} r ( {iT}_{c} + SignalSamplingStart ) * pn ( i + PseudoNoiseInitialPhase )$$

In this equation, r is the input signal value and pn is the spreading code (or scrambling) used in spreading (or scrambling) the transmitted signal. The delay of each measured channel value generated by one of correlator elements 110 (FIG. 2) may be defined as the difference between pseudo-noise initial phase 408 and the signal sampling start times 404. Hypotheses numbers 410 correspond with the delay that is being checked. In this embodiment, the maximal delay between the check (e.g., the start time) of two consecutive hypotheses is less than or equal to approximately one symbol. As a result, there may be very little degradation in interpolation accuracy. In other embodiments, the delay between any two hypotheses checks may be, for example, any positive number.

In this example, to check hypotheses numbers one through four, the first two correlators are started with little relative delay (see rows 411 and 412 of table 400), the third correlator (see row 413) is started with a one-symbol delay, and the fourth correlator (see row 414) is started with a two-symbol delay. To check hypotheses number five, the first correlator (see row 415) may be started with a three-symbol delay. Because of a correlation length of three, the first correlator will have completed the check of hypotheses number one prior to the start of the check of hypotheses number five. To check hypotheses numbers six, seven and eight, the second, third and fourth correlators have a start time delayed by three, four and five symbols, respectively (see rows 416, 417 and 418). Subsequent hypotheses numbers not listed in table 400 may be similarly checked.

In one embodiment of the present invention, any two sequential correlators may have about the same signal-sampling start time. For example correlators two and three may have about the same start time rather than correlators one and two as illustrated in table 400. In an embodiment of the present invention that includes five correlators with a correlation length of three symbols, the first three correlators, for example, may have about the same start time. Alternatively, correlators one and two may have about the same start time, and correlators three and four may have about the same start time. The signal sampling start time difference between consecutive correlators may be one symbol or less.

In accordance with at least one of the various embodiments of the present invention, there may be N correlators where N may range between two and seventeen or more, and may check hypotheses' over a correlation length “m”. In these embodiments, the (N+1)th hypotheses may be checked with delay of m symbols. The first N−m+1 correlator may start with a delay of zero symbols, the N−m+2 correlator may start with a delay of one symbol, the (N−m+3) correlator may start with a delay of two symbols, etc. The correlator checking the Nth hypotheses may be started at time tₘ₋₁, and the correlator checking the N+1 hypotheses check may be started with a delay of m symbols. This N+1th hypotheses check may be performed by the first correlator, which may have completed its first check. The correlation length m may range between one and sixteen symbols or more. The correlation length may be less than the number of correlators, although in another embodiment, the correlation length may be equal to or greater than the number of correlators used for searching.

In accordance with embodiments of the present invention, the receiver may improve searching for signal paths of a spread-spectrum signal. The receiver may also reduce power consumption by as much as fifty percent or more. Search time and/or the amount of hardware for searching may also be reduced significantly. In one embodiment, an improved CDMA receiver is provided with accelerated searching. Accelerated searching for signal paths of a spread-spectrum signal may be achieved by sampling the I and Q components of a received approximately once per chip and summing the samples to determine a measured channel value at a specific delay. The summing may be done with signal samples having a delay therebetween of one chip. The delay between sequentially checked paths may be one or less chips. An interpolated channel value may be estimated for each delay of the spreading code based on the measured channel values. Signal paths may be selected based on the measured and interpolated channel values.

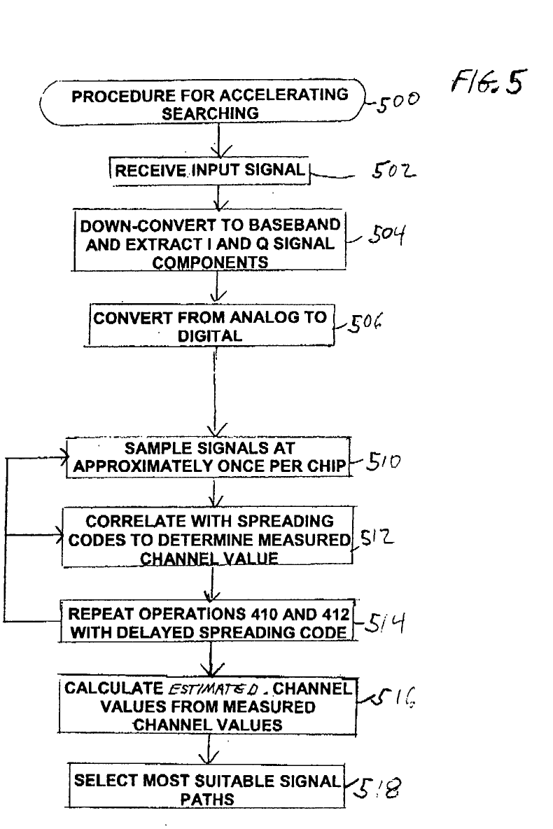

FIG. 5 is a flow chart of a procedure for accelerating searching in accordance with an embodiment of the present invention. Although the individual operations of procedures 500 are illustrated and described as separate operations, one or more of the individual operations may be performed concurrently. Further, nothing requires that the operations be performed in the order illustrated. The operations of procedure 500 may be performed, for example, by the various functional elements of receiver 100 (FIG. 1) and/or searcher 106 (FIG. 2) or may be performed by other suitably configured hardware, including a digital signal processor configured with software. In general, procedure 500 performs accelerated searching for signal paths of a spread-spectrum signal by sampling the I and Q components of a received signal at approximately once per chip and summing weighted samples over one or more symbols to determine a measured channel value at a specific delay. The delay between sequentially checked paths may be one chip or less. A channel value may be estimated for each delay of the spreading code based on the measured channel values. Most suitable signal paths may be selected based on the channel value for use in subsequent signal tracking.

Operation 502 receives a spread spectrum input signal, such as CDMA or WCDMA signal by a receiver. Operation 504 down-converts the received signal to baseband and extracts the I and Q components. Antenna 102 (FIG. 1) and front end 104 (FIG. 1), for example, may perform operations 502 and 504.

Operation 506 digitizes the I and Q components. The sampling rate of an analog to digital (A/D) converter performing an A/D conversion in operation 506 may be greater than once per chip. An A/D converter within front end 104 (FIG. 1), for example, may perform operation 506. Operation 506 may also shape the digitized I and Q signals with a filter, such as a pulse shaping FIR or IIR filter.

Operation 510 samples the signals at a rate that may be approximately once per chip. Operation 512 correlates the sampled I and Q signals with a spreading code to produce a measured channel value. Operation 512 may include performing a weighted summing of the samples over a plurality of symbols to generate a channel value. Operation 514 repeats operation 512 for various delays of the spreading code and signal sampling delay. Although operations 510 and 512 are illustrated as separate operations, the operations may also be performed in parallel. During the performance of operation 514, pseudo-random initial phase and signal sampling start time may be delayed in accordance with table 400 (FIG. 4), or other values. Correlators 110 (FIG. 2), for example, may perform operations 510 and 512 and delay elements 114 (FIG. 2), for example, may be configured by controller 116 (FIG. 2) to provide suitable delay. The measured channel values determined in operations 512 and 514, for example, may correspond with measured channel values 121 through 130 (FIG. 2).

Operation 516 determines interpolated channel values from the measured channel values determined in operations 512 and 514. The interpolated channel values may be calculated by interpolator elements 118 (FIG. 2) for the various hypotheses previously described. Interpolator elements 118, (FIG. 2), for example, may perform operation 516. The interpolated channel values may correspond with interpolated channel values 131 through 140 (FIG. 2).

Operation 518 selects one or more signal paths based on the measured channel values and interpolated channel values at various delays. In one embodiment, the signal paths having the greater power than other signal paths may be selected. Operation 518 may be performed, for example, by path selection element 120 (FIG. 2) to provide, for example, several paths with greater power that other paths.

Thus, a method and receiver have been described which may improve searching for signal paths of a spread-spectrum signal. The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the invention embraces all such alternatives, modifications, equivalents and variations as fall within the spirit and broad scope of the appended claims.

What is claimed is:

1. A communications method comprising:
summing weighted measured channel values of a multipath spread-spectrum signal to generate estimated channel values; and
selecting signal paths based on the estimated and measured channel values.

2. The method of claim 1 wherein summing comprises weighting measured channel values in accordance with a low-pass filter function to produce the weighted channel values; and
coherently summing the weighted channel values to generate the estimated channel values.

3. The method of claim 1 wherein the measured channel values have delays associated therewith, and wherein the summing comprises summing the measured channel values with delays therebetween of substantially one chip.

4. The method of claim 1 further comprising calculating the measured channel values by correlating an input signal at signal sampling start times for a correlation length substantially according to the following equation:
$${\sum }_{i = 0}^{CorrelationLenth - 1} r ( {iT}_{c} + SignalSamplingStart ) * pn ( i + PseudoNoiseInitialPhase )$$
wherein r(iT_{c}+SignalSamplingStart) is an input signal value at time iT_{c}+SignalSamplingStart, pn is a spreading code, and the pseudo noise initial phase is an initial phase of a correlator performing the correlating.

5. The method of claim 4 wherein correlating comprises performing consecutive correlations wherein the signal sampling start time between at least some consecutive correlations is no greater than approximately one symbol, and wherein the initial phase of the correlator performing the correlating is increased by approximately one chip between the consecutive correlations.

6. The method of claim 2 wherein coherently summing comprises generating the estimated channel values (rₓ) substantially in accordance with the following equation:
rₓ=sin c(t₁)r₁+sin c(t₂)r₂+sin c(t₃)r₃+sin c(t₄)r₄+sin c(t₅)r₅+sin c(t₇)r₇+sin c(t₈)r₈,
wherein r₁ through r₈ are measured channel values having delays at of substantially one chip therebetween,
wherein t₁ through t₈ are the delays between one of the measured channel values and an estimated channel value in chips,
wherein sin c (t₁) through sin c (t₈) are weighting factors, and
wherein sin c (x) is a (sin πx)/πx function.

7. The method of claim 6 wherein t₁ is approximately 3.5 chips, t₂ is approximately 2.5 chips, t₃ is approximately 1.5 chips and t₄ is approximately 0.5 chips t₅ is approximately −0.5, t₆ is approximately −1.5, t₇ is approximately −2.5 and t₈ is approximately −3.5

8. The method of claim 1 further comprising:
sampling a received signal to generate samples; and
correlating the samples over a plurality of symbols to generate the measured channel values,
wherein the correlating is performed for various delays of a spreading code for a correlation length of a predetermined number of symbols, and
wherein the sampling is performed at approximately a chip rate.

9. The method of claim 8 wherein the correlating is performed by correlators at predetermined signal sampling start times and a pseudo-random initial phase, wherein the signal sampling start times between at least some of the correlators are an integer number of chips per symbol.

10. The method of claim 9 wherein the measured channel values generated by the correlators have a delay associated therewith, the delay being a difference between the pseudo-random initial phase and the signal sampling start time for an associated correlator.

11. The method of claim 2 wherein coherently summing the weighted measured channel values is performed with a processor.

12. A searcher comprising:
an interpolator to sum weighted channel values to generate estimated channel values; and
a path selection element to select signal paths based on the estimated and measured channel values.

13. The searcher of claim 12 wherein the interpolator sums weighted channel values in accordance with a low-pass filter function to produce weighted channel values and coherently summing the weighted channel values to generate the estimated channel values.

14. The searcher of claim 12 wherein the weighted channel values have delays associated therewith, and wherein the interpolator sums the weighted channel values with delays therebetween of substantially one chip.

15. The searcher of claim 12 further comprising a correlator to determine measured channel values for weighted summing by the interpolator, the measured channel values being determined by correlating an input signal at signal sampling start times for a correlation length by substantially implementing the following equation:
$${\sum }_{i = 0}^{CorrelationLenth - 1} r ( {iT}_{c} + SignalSamplingStart ) * pn ( i + PseudoNoiseInitialPhase )$$
wherein r(iT_{c}+SignalSamplingStart) is an input signal value, pn is a spreading code, and the pseudo noise initial phase is an initial phase of the correlator.

16. The searcher of claim 15 wherein the correlator performs consecutive correlations wherein the signal sampling start time between at least some consecutive correlations is no greater than approximately one symbol, and wherein the initial phase of the correlator is increased by one chip between the consecutive correlations.

17. The searcher of claim 12 wherein the interpolator generates the estimated channel values (r_{X}) by substantially implementing the following equation:
rₓ=sin c(t₁)r₁+sin c(t₂)r₂+sin c(t₃)r₃+sin c(t₄)r₄+sin c(t₅)r₅+sin c(t₇)r₇+sin c(t₈)r₈,
wherein r₁ through r₈ are measured channel values having delays at of substantially one chip therebetween,
wherein t₁ through t₈ are the delays between one of the measured channel values and an estimated channel value in chips,
wherein sin c (t₁) through sin c (t₈) are weighting factors, and wherein “sin c” is a (sin πx)/πx function.

18. The searcher of claim 17 wherein t₁ is approximately 3.5 chips, t₂ is approximately 2.5 chips, t₃ is approximately 1.5 chips, t₄ is approximately 0.5 chips t₅ is approximately −0.5, t₆ is approximately −1.5, t₇ is approximately −2.5 and t₈ is approximately −3.5

19. A computer readable medium having program instructions stored thereon for performing a method of searching for a signal path of a multipath spread-spectrum signal when executed within a digital processing device, the method comprising:
summing weighted measured channel values to generate estimated channel values; and
selecting signal paths based on the estimated and measured channel values.

20. The computer readable medium of claim 19 wherein summing comprises weighting measured channel values in accordance with a low-pass filter function to produce weighted channel values, and coherently summing the weighted channel values to generate the estimated channel values.

21. The computer readable medium of claim 20 wherein the measured channel values have delays associated therewith, and wherein the summing comprises summing measured channel values with delays therebetween of substantially one chip.

22. A digital signal processor comprising:
an interpolating element to sum weighted channel values to generate estimated channel values; and
a path selection element to select signal paths based on the estimated channel values and on measured channel values.

23. The digital signal processor of claim 22 wherein the interpolating element weights measured channel values in accordance with a low-pass filter function to produce weighted channel values and coherently sums the weighted channel values to generate the estimated channel values.

24. The digital signal processor of claim 22 wherein the measured channel values have delays associated therewith, and wherein the interpolating element sums the measured channel values with delays therebetween of substantially one chip.

25. The digital signal processor of claim 22 further comprising correlating elements to sample a received signal, to generate samples, and to correlate the samples over a plurality of symbols to generate measured channel values.

26. A spread-spectrum receiver comprising:
a searcher to identify delays associated with strong signal paths; and
a tracker to track the strong signal paths during receipt of communications,
wherein the searcher includes an interpolator to sum weighted channel values to generate estimated channel values, and a path selection element to select the strong signal paths based on the estimated and measured channel values.

27. The spread-spectrum receiver of claim 26 wherein the interpolator sums weighted channel values in accordance with a low-pass filter function to produce weighted channel values and coherently summing the weighted channel values to generate the estimated channel values.

28. The spread-spectrum receiver of claim 26 wherein the weighted channel values have delays associated therewith, and wherein the interpolator sums the weighted channel values with delays therebetween of substantially one chip.

29. The spread-spectrum receiver of claim 26 further comprising a front end to receive and digitize received signals and to provide the searcher a shaped moving average of the received signal using a shaping filter.
